(19) United States
(12) Patent Application Publication
(10) Pub. No.: US 2005/0262206 A1
(43) Pub. Date: Nov. 24, 2005

(54) Selective commenting in an e-mail message

(75) Inventors: Diane Weir, Westford, MA (US); Robert C. Weir, Westford, MA (US)

Correspondence Address: CHRISTOPHER & WEISBERG PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/839,832

(22) Filed: May 6, 2004

(51) Int. Cl. G06F 15/16

(52) U.S. Cl. 709/206

(57) ABSTRACT

A method, system and apparatus for selective commenting in an e-mail message. A selective commenting method can include the steps of designating two or more recipients for an e-mail message, and selecting a subset of recipients from among the designated recipients. A comment to the e-mail message can be composed and the e-mail message can be transmitted to the designated recipients. Importantly, the comment can be included with the transmission only for the selected subset. In this regard, the including step can include the step of embedding the comment in the e-mail message. To that end, the including step further can include the step of visually formatting the comment to be distinct from a remainder of the e-mail message. Alternatively, the including step further can include the step of demarcating the comment so as to distinguish the comment from a remainder of the e-mail message.

### BACKGROUND OF THE INVENTION

1. Statement of the Technical Field

The present invention relates to electronic mail (e-mail), and more particularly to the attachment of comments to e-mail messages.

2. Description of the Related Art

Electronic mail, referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications save for voice telephony.

Strictly speaking, an e-mail is a document which has been universally formatted and which can be carried as a payload to a message in an inter-process communications session between two or more computing devices. E-mail client software can be charged with the composition of the underlying message and its configuration into a universally recognizable format. E-mail client software further can be charged with the interpretation of an e-mail message from its universally format into a presentable format which can be understood by the recipient. Importantly, as e-mail messages can be formatted in a universally recognizable format, e-mail can be exchanged between communicants regardless of the type of e-mail client utilized by the communicants so long as the e-mail clients are configured to process the universally recognizable format.

E-mail distribution lists have evolved to permit group communications between a message source and a group of message recipients. As a matter of convenience, a message can be composed and addressed to multiple, different recipients—some directly, some by way of carbon copy, and some by way of blind carbon copy. As a common element, however, all of the content of the composed message can be delivered in identical form to each designated recipient. Occasions arise, however, where it is desired to privately communicate with individual ones of the designated recipients as an addition to the content of a message transmitted to the group of designated recipients.

To accommodate the need for ad hoc private communication with only selected members of a group of designated recipients, presently follow-on e-mail messages to the primary e-mail message are composed and transmitted to the selected members of the group of designated recipients. The primary e-mail message and the follow-on e-mail message are transmitted separately, though, as conventional e-mail clients cannot support the selective inclusion of text only for particular ones of a group of designated recipient. For the sporadic need to engage in private communications among a selection of designated recipients, the inefficiencies of the separate transmission of primary and follow-on e-mail messages can be tolerated. Yet, for more frequent usage, particularly where storage resource consumption, e-mail message management, and e-mail message audit trails are of importance, the conventional methodology cannot be tolerated.

### SUMMARY OF THE INVENTION

The present invention addresses the deficiencies of the art in respect to transmitting a comment in association with an e-mail message. As such, the present invention provides a novel and non-obvious method, system and apparatus for selectively incorporating a supplemental message in an associated e-mail message for particular recipients of the e-mail message. An e-mail transmission system which has been configured in accordance with the present invention can include an interface to a mail server and a selective commenting processor coupled to the interface.

The selective commenting processor can be configured for transmitting through the interface both a primary message and also one or more secondary messages to one or more respective subsets of recipients designated to receive the primary message. Notably, the selective commenting processor can be disposed in an e-mail client, or in an e-mail server. Also, each of the secondary messages can be embedded in the primary message for the respective subset. In that case, the secondary messages can be demarcated in the primary message to be distinguishable from the primary message. Similarly, the secondary messages can be formatted to be distinguishable from the primary message.

A selective commenting method can include the steps of designating two or more recipients for an e-mail message, and selecting a subset of recipients from among the designated recipients. A comment to the e-mail message can be composed and the e-mail message can be transmitted to the designated recipients. Importantly, the comment can be included with the transmission only for the selected subset. In this regard, the including step can include the step of embedding the comment in the e-mail message. To that end, the including step further can include the step of visually formatting the comment to be distinct from a remainder of the e-mail message. Alternatively, the including step further can include the step of demarcating the comment so as to distinguish the comment from a remainder of the e-mail message.

In consequence of the foregoing inventive methodology, the transmission along with the included comment can be logged as a single transmission in an audit trail. Also, the transmission with the included comment can be stored as a single e-mail transmission. Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an e-mail message transmission system which has been configured in a preferred aspect of the present invention;

FIGS. 2A through 2C are screen-shot illustrations of an e-mail client in the course of selectively transmitting a comment to designated recipients of an e-mail in the system of FIG. 1; and,

FIG. 3 is a flow chart illustrating a process for selectively transmitting a comment to designated recipients of an e-mail message in the system of FIG. 1.

### DETAILED DESCRIPTION OF THE PREFERRED EMBODIMENTS

The present invention is a method, system and apparatus for selectively transmitting a comment to designated recipients of an e-mail message. In accordance with the present invention, an e-mail processing system can be configured to selectively comment an e-mail message for transmission to specified ones of a set of designated recipients. Specifically, a primary message can be composed and a set of recipients can be designated to receive the primary message. One or more of the recipients further can be designated to receive one or more supplemental messages. The supplemental messages can be composed and transmitted along with the primary message only to those recipients designated to receive the supplemental messages. The other designated recipients can receive only the primary message in the transmission.

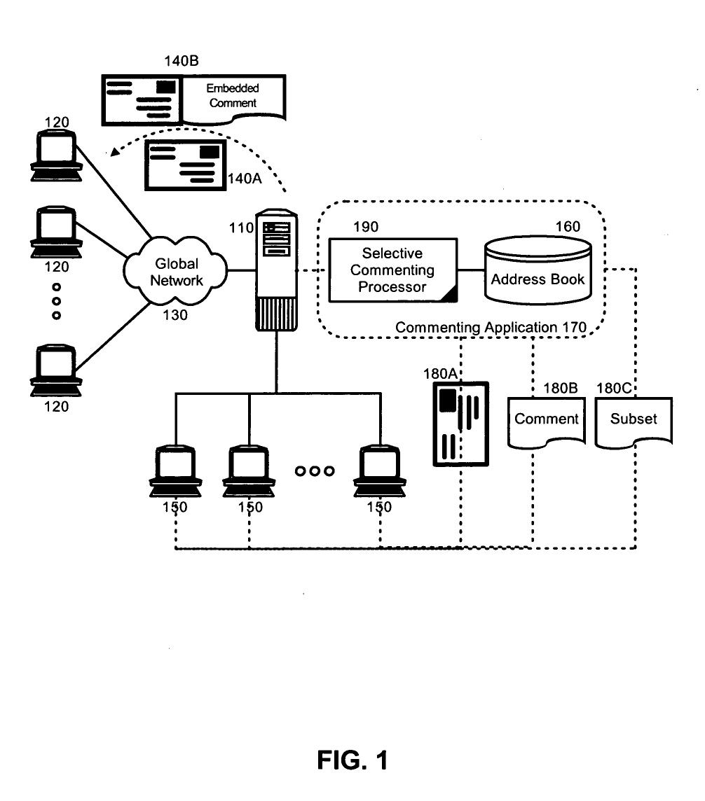

In further illustration of the foregoing invention, FIG. 1 is a schematic illustration of an e-mail message transmission system which has been configured in a preferred aspect of the present invention. As shown in FIG. 1, a mail server 110 can be coupled to one or more mail clients 150. Each mail client 150 can include application software for composing e-mail messages. Using the mail server 110, the mail clients 150 can transmit composed e-mail messages to designated ones of the mail recipients 120 over a communications network 130, for example a global communications network such as the Internet, or a local area network (not shown).

In accordance with the present invention, a commenting application 170 can be coupled either to the mail server 110, to the mail clients 150, or to both. Moreover, selected programmatic portions of the commenting application 170 can be coupled to either or both of the mail server 110 and the mail clients 150. In any case, the commenting application 170 can include a selective commenting processor 190 and, optionally, an address book 160. The address book 160 can include a data store of known e-mail addresses of the recipients 120. Using the address book 160, an author can designate particular ones of the recipients 120 for receiving an e-mail message composed through the clients 150. Alternatively, the author can manually designate the particular ones of the recipients 120.

The selective commenting processor 190 can include program logic for associating a supplemental message with particular ones among the designated recipients 120. In this regard, a primary message 180A can be composed through the e-mail clients 150. One or more of the recipients 120 can be designated to receive the primary message 180A. Additionally, a subset 180C of the designated recipients 120 can be established to receive a supplemental message 180B, for example a textual comment. It will be recognized by the skilled artisan, however, that the supplemental message 180B is not limited to a comment and can include audio, visual or audiovisual material, just to name a few examples.

In any case, the program logic of the selective commenting processor 190 can combine the supplemental message 180B with the primary message 180A to form a composite message 140B. The composite message 140B, in turn can be transmitted over the network 130 only to those of the recipients 120 included in the subset 180C. For the other designated ones of the recipients 120, only the primary message 140A will be transmitted. In this way, selected ones of the recipients can receive the supplemental message in a single e-mail transmission without requiring a follow-on e-mail. As such, storage resource consumption for e-mail messages can be reduced, e-mail message management can be facilitated, and e-mail message audit trails can be maintained more accurately.

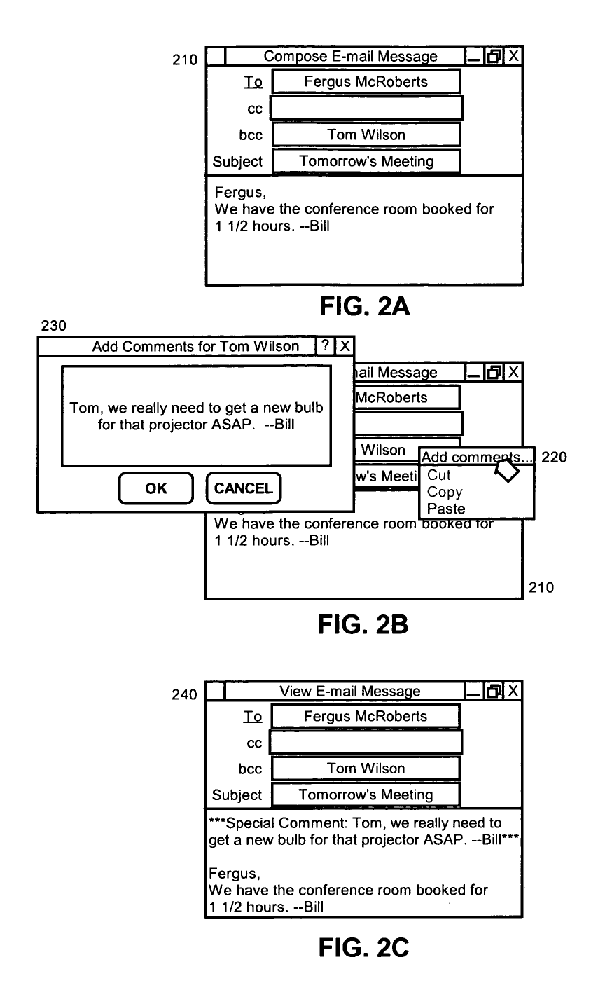

FIGS. 2A through 2C are screen-shot illustrations of an e-mail client in the course of selectively transmitting a comment to designated recipients of an e-mail message in the system of FIG. 1. Considering FIG. 2A first, an e-mail message composition window 210 can be rendered in which an e-mail message can be composed, and further in which one or more designated recipients can be specified. In the exemplary illustration of FIG. 2A, two recipients can be designated to receive the primary message.

In FIG. 2B, the second designated recipient, “Tom Wilson” can be selected to receive a supplemental message through the operation. In this regard, a drop down window 220 can be rendered in association with the selected recipient, although the skilled artisan will recognize a multitude of ways to activate an option to add the supplemental message in association with one or more designated recipients. Responsive to selecting the “Add comments” option in the drop down box 220, a supplemental message window 230 can be rendered through which the supplemental message can be composed.

In FIG. 2C, the recipient selected to receive the supplemental message in conjunction with the primary message (Tom Wilson) can view the composite message in a view message window 240. Notably, the supplemental message can be denoted as such, for instance by varying the typeface of the supplemental message, or by demarcating the supplemental message with text such as “Special Comment”. For those designated recipients, however, which have not been selected to receive the supplemental message, only the primary message will be viewed through the view message window. Yet, the sender need only compose and transmit (from the perspective of the sender) a single e-mail transmission.

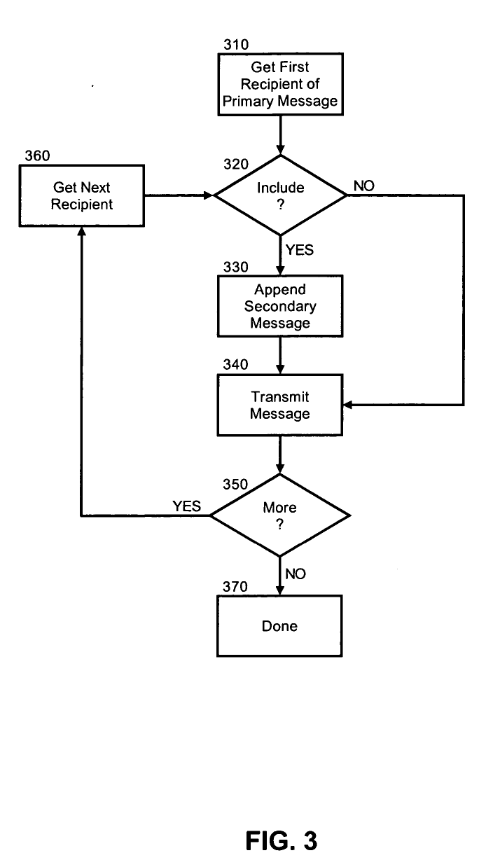

The commenting application of the present invention can process the selective transmission of the composite message according to the designated subset of recipients who are to receive the composite message. In more particular illustration, FIG. 3 is a flow chart illustrating a process for selectively transmitting a composition of a composed primary and supplemental message to designated recipients of an e-mail message in the system of FIG. 1. Beginning in block 310, a first designated recipient of the composed primary message can be identified.

If in decision block 320 the identified recipient had not been selected to receive the supplemental message, in block 340 the primary message only can be transmitted to the identified recipient. Otherwise, in block 330 the secondary message can be appended to, embedded within or associated with the primary message. Subsequently, in block 340 the composition can be transmitted to the identified recipient. In block 350, if more designated recipients remain to be processed, in block 360 the next identified recipient can be retrieved and the process can repeat through block 320. When no more designated recipients remain to be processed, in block 370 the process can end.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. An e-mail transmission system comprising:
an interface to a mail server; and,
a selective commenting processor coupled to said interface and configured for transmitting through said interface both a primary message and also a secondary message to a subset of recipients designated to receive said primary message.

2. The system of claim 1, wherein said selective commenting processor is disposed in an e-mail client.

3. The system of claim 1, wherein said selective commenting processor is disposed in an e-mail server.

4. The system of claim 1, wherein said secondary message is embedded in said primary message for said subset.

5. The system of claim 4, wherein said secondary message is demarcated in said primary message to be distinguishable from said primary message.

6. The system of claim 4, wherein said secondary message is formatted to be distinguishable from said primary message.

7. A selective commenting method comprising the steps of:
designating a plurality of recipients for an e-mail message;
selecting a subset of recipients from among said designated recipients;
composing a comment to said e-mail message;
transmitting said e-mail message to said designated recipients; and,
including said comment with said transmission only for said selected subset.

8. The method of claim 7, wherein said including step comprises the step of embedding said comment in said e-mail message.

9. The method of claim 8, wherein said including step further comprises the step of visually formatting said comment to be distinct from a remainder of said e-mail message.

10. The method of claim 8, wherein said including step further comprises the step of demarcating said comment so as to distinguish said comment from a remainder of said e-mail message.

11. The method of claim 7, further comprising the step of logging said transmission with said included comment as a single transmission in an audit trail.

12. The method of claim 7, further comprising the step of storing said transmission with said included comment as a single e-mail transmission.

13. A machine readable storage having stored thereon a computer program for selective commenting, the computer program comprising a routine set of instructions which when executed by a machine cause the machine to perform the steps of:
designating a plurality of recipients for an e-mail message;
selecting a subset of recipients from among said designated recipients;
composing a comment to said e-mail message;
transmitting said e-mail message to said designated recipients; and,
including said comment with said transmission only for said selected subset.

14. The machine readable storage of claim 13, wherein said including step comprises the step of embedding said comment in said e-mail message.

15. The machine readable storage of claim 14, wherein said including step further comprises the step of visually formatting said comment to be distinct from a remainder of said e-mail message.

16. The machine readable storage of claim 14, wherein said including step further comprises the step of demarcating said comment so as to distinguish said comment from a remainder of said e-mail message.

17. The machine readable storage of claim 13, further comprising the step of logging said transmission with said included comment as a single transmission in an audit trail.

18. The machine readable storage of claim 13, further comprising the step of storing said transmission with said included comment as a single e-mail transmission.
